(19) United States
(12) Patent Application Publication
(10) Pub. No.: US 2026/0171933 A1
(43) Pub. Date: Jun. 18, 2026

(54) FLEXIBLE ELECTROADHESIVE PAD HAVING A DEFORMABLE LAYER

(71) Applicant: The Charles Stark Draper Laboratory, Inc., Cambridge, MA (US)

(72) Inventors: Louis B. Kratchman, Cambridge, MA (US); Nicholas A. Zervoglos, Cambridge, MA (US); Linda K. Williams, Cambridge, MA (US); Rebecca A. DeFronzo, Cambridge, MA (US)

(21) Appl. No.: 19/419,493

(22) Filed: Dec. 15, 2025

Related U.S. Application Data
(60) Provisional application No. 63/733,929, filed on Dec. 13, 2024.

(51) Int. Cl. H02N 15/00; B25J 15/00; B25J 15/06; B62D 57/024

(52) U.S. Cl. CPC H02N 15/00; B25J 15/008; B25J 15/0608; B62D 57/024

(57) ABSTRACT

A flexible electroadhesive pad includes a plurality of layers and one or more electrodes. The plurality of layers includes a deformable layer having an elastic deformable material, a first layer having a material providing rigid support, and a second layer. The first layer has a first side and a second side opposed to the first side. The deformable layer is coupled to the first side and the second layer is coupled to the second side of the first layer. The electrodes are at least partially disposed within the second layer, and are configured to generate an electrostatic force to cause adhesion of the flexible electroadhesive pad to a surface.

### CROSS-REFERENCE TO RELATED APPLICATIONS

This application claims priority to U.S. provisional application Ser. No. 63/733,929 filed Dec. 13, 2024, the disclosure of which is hereby incorporated in its entirety by reference herein

### STATEMENT OF GOVERNMENT SUPPORT

This invention was made with government support under CON086781. The government has certain rights in the invention.

### TECHNICAL FIELD

Aspects of the disclosure generally relate to an electroadhesive pad using electrostatic force to adhere to a surface.

### BACKGROUND

Electrostatic adhesives can enable adhesion to surfaces. By generating an electric field, an electrostatic force can cause astriction between two or more surfaces in contact with each other.

### SUMMARY

In one or more illustrative examples, a flexible electroadhesive pad includes a deformable layer, a first layer, a second layer, and one or more electrodes. The deformable layer comprises an elastic deformable material. The first layer comprises a material providing rigid support and has a first side and a second side opposed to the first side. The deformable layer is coupled to the first side and the second layer is coupled with the second side of the first layer. The one or more electrodes are at least partially disposed within the second layer. The one or more electrodes are configured to generate an electrostatic force to cause adhesion of the flexible electroadhesive pad to a surface.

In one or more illustrative examples, a flexible electroadhesive pad includes a body and one or more electrodes. The body includes a deformable layer that comprises an elastic deformable material, a rigid layer comprising a material providing inelastic support, a back layer, and a contact layer. The rigid layer is coupled to the deformable layer at a first side of the rigid layer. The back layer is coupled to a second side of the rigid layer. The contact layer is coupled to a side of the back layer different from that of the rigid layer. Theone or more electrodes are at least partially disposed within the back layer, and are configured to generate an electrostatic force to have the body adhere to a surface with the contact layer contacting the surface.

### BRIEF DESCRIPTION OF THE DRAWINGS

The foregoing and other objects, aspects, features, and advantages of the disclosure will become more apparent and better understood by referring to the following description taken in conjunction with the accompanying drawings. The accompanying drawings are not intended to be drawn to scale. Like reference numbers and designations in the various drawings indicate like elements. For purposes of clarity, not every component may be labeled in every drawing. In the drawings:

FIG. 1 illustrates a cross-sectional view of a flexible electroadhesive pad in accordance with the present disclosure;

FIG. 2 illustrates a cross-sectional view of an example flexible electroadhesive pad;

FIG. 3 illustrates a track system in accordance with the present disclosure;

FIG. 4A illustrates a coupling mechanism to couple a pad to a track in accordance with the present disclosure;

FIG. 4B illustrates a side view of the coupling mechanism of FIG. 4A; and

FIG. 5 illustrates tilted pads partially and fully in contact with a surface.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Electroadhesion forces can be effective at very short distances, therefore conventional electroadhesion devices must closely match the shapes of surfaces that to which they are to be applied. Some electroadhesion devices are formed either of flexible substrates or of rigid substrates. In some cases, electroadhesion devices formed with flexible substrates can provide adhesion to non-flat surfaces, since the flexible substrates can conform to the shape of the surfaces. However, such devices provide very poor adhesive forces in the direction normal to the plane of the device. Such devices can provide strong shear forces but provide very weak normal forces, since the flexible substrate tends to peel away from a surface when subjected to forces normal to the targeted surface. Alternatively, rigid substrates provide strong normal forces and shear forces when target surfaces are very flat but can perform poorly with surfaces that are not flat.

Electroadhesive devices may be used in various applications, such as, but not limited to: vehicle systems to propel or move a vehicle, and a material handling system to hold/grip and transport material/packages. For example, electroadhesive devices can provide traction or adhesion to a surface to enable a vehicle to travel on said surface. However, if the electroadhesive device is unable to provide adequate normal force, the vehicle may encounter reduced or even failed movement. Electroadhesive devices can be susceptible to a “peeling” effect, wherein the device “peels” or becomes unattached from the surface due to a lack of contact between the device and the pad causing inadequate normal forces to maintain adhesion. Adequate normal force can provide adhesion or traction necessary for vehicle movements.

In the example vehicle application, a lack of appropriate traction or adhesion between a track of the vehicle and the surface on which it travels can prevent vehicles from ascending or descending at certain angles of incline, especially when using flexible substrate electroadhesive devices. For example, at a certain angle of incline, the vehicle may no longer travel as intended due to a lack of traction between the vehicle and the surface. Further, adequate normal force to ensure traction or adhesion between the track system of the vehicle and a surface on which the vehicle is maneuvering can vary due to variations in the surface. Adequate normal force in situations with varied surfaces is difficult for rigid substrate electroadhesive devices to overcome, as described above. Difficulties in movement arise for a vehicle to travel on inclined, uneven, and combination of those surfaces. In conventional track systems, the traction may not be sufficient to enable vehicle movement, resulting in slipping between the track system and the surface.

In another example, in material handling applications, electroadhesive devices may exhibit performance challenges associated with both gripping and release. For instance, insufficient electrostatic coupling can result in inadequate holding force, whereas excessive adhesion can cause undesirable peeling dynamics or substrate deformation during release. These effects are particularly pronounced when handling thin or flexible materials such as films or fabrics.

While specific issues related to electroadhesive devices in vehicle and material handling applications are described, other applications that employ electroadhesive devices are within the scope of the present disclosure. For example, in the semiconductor industry, semiconductor wafers may be handled using Coulumbic chucks and/or Johnsen-Rahbek chucks that have one electrode in the device itself (the material to be handled is grounded to the same circuit that applies voltage to the devices).

To account for these and other technical problems, the system and methods described herein provide a flexible electroadhesive device that is applicable to non-flat surfaces and which provides both normal and shear electroadhesion. In an illustrative example, a vehicle having a track system includes a flexible electroadhesion devices of the present disclosure for electrostatic adhesion of the vehicle to a surface. The vehicle can include a track coupled to the electroadhesion device to enable advanced vehicle movements, such as ascending or descending steep inclines, vertical travel (e.g., up a wall), and reduction of slipping between the surface and the track itself. The systems and methods described herein can overcome normal forces, gravitational, or other forces which may prevent or inhibit movement in conventional systems.

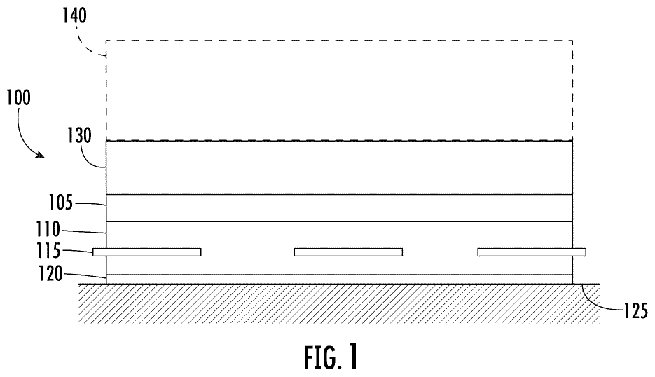

FIG. 1 illustrates a cross-sectional view of a flexible electroadhesive device 100, which may also be referred to as a flexible electroadhesive pad 100 or even pad 100. The flexible electroadhesive pad 100 may include one or more layers, such as a rigid backing 105, a back layer 110, electrodes 115, and a contact layer 120. The pad 100 or one of its layers may be in contact with a surface 125. The layers of the flexible electroadhesive pad 100 can be coupled to one another to provide adhesion to the surface 125. Embodiments may comprise additional or alternative components or omit certain components from those of FIG. 1, and still fall within the scope of this disclosure.

The rigid backing 105 (e.g., rigid layer) may be stiffen or be still to provide rigid (e.g., inelastic) support to one or more of the other layers of the pad 100. In this manner, the rigid backing 105 may aid in providing a strong normal force (e.g., adhesion) between the pad 100 and the surface 125. In an illustrative example, the rigid backing 105 may be a first layer of the pad 100 and has a first side opposed to a second side. In some cases, the first side of the rigid backing 105 is coupled to a deformable layer 130 (e.g., compressible material) and the second side of the rigid backing 105 may couple with the back layer 110. As detailed herein, the deformable layer 130 comprises an elastic deformable material that is a material that undergoes reversible deformation under an applied force and substantially returns to its original shape upon removal of the force, without permanent deformation. With at least this characteristic, the deformable layer 130 imparts flexibility to the pad 100, allowing the pad 100 to tilt or conform to the contour of the surface 125. This flexibility enhances the contact area and gripping effectiveness of the pad 100. In some aspects, the rigid backing 105, the back layer 110, the contact layer 120, and the deformable layer 130 form a body of the pad 100.

The back layer 110 at least partially surrounds the electrodes 115 and functions primarily as a dielectric to insulate or inhibit electrical breakdown. The back layer 110 may comprise flexible material such as but not limited to polyimide, silicone, and other polymers. Therefore, the rigid layer 105 complements the flexibility of the back layer 110. For some materials defining the back layer 110, an additional rigid backing 105 is unnecessary.

In some cases, the rigid backing 105 includes or is a material that may change rigidity upon application of a force, such as a magnetic, electrical, or pressure force. Examples of these materials can include a magnetorheological material upon application of a magnetic field, an electroactive material upon application of an electric field, a phase change material upon application or removal of heat, a shape memory alloy upon application of heat, a shape memory polymer upon application of heat or light, an electrohydraulic material, a jamming material upon application of a vacuum, etc. This enables the electroadhesive pad 100 to conform to changes in the surface 125. In some cases, the rigid backing 105 includes or is a rigid material such as glass, metals, silicon, rigid plastics, among others and may not change rigidity.

The magneto/electrorheological layer may be made rigid after conforming to a non-flat surface, thereby combining the advantages of a purely flexible pad (conformability) with that of a pad with a permanent rigid backing (normal force). The magneto/electrorheological layer may be a selectively flexible/rigid layer that could replace the rigid backing 105, or potentially replace 105, 110, and 120, and 105 if it possesses sufficient dielectric strength. A pad with only a deformable layer 130 can tilt to obtain good contact with an inclined or non-flat surface, but a magneto/electrorheologically backed pad can conform to both the shape and inclination of a non-flat surface.

The surface 125 may be any kind of surface to which the pad 100 adheres. For example, the surface 125 includes or is a conductive material, such as copper, gold, aluminum, tungsten, conductive polymers, graphene, carbon nanotubes, composite materials, among others. In another example, the surface 125 is an insulative material, such as ceramic, rubber, stone, among others. In yet another example, the surface 125 is a ferromagnetic material, such as iron or cobalt, among others. In another example, the surface 125 is a semiconductive material, such as silicon, germanium, among others. In some cases, the surface 125 is traversed by a vehicle.

In some aspects, the contact layer 120 may be in contact with the surface 125. The contact layer 120 (e.g., third layer of the pad 100) may be part of the back layer 110 or coupled with the back layer 110. The contact layer 120 encloses the electrodes 115 within the back layer 110. The contact layer 120 may perform various functions, such as, but not limited to: anti-slipping function using its high friction properties; local conformability to prevent formation of pockets at the layer or surface interface, where the pockets can cause localized discharge that can degrade materials; adhesion by other means, such as chemical or mechanical interlocking, as may be beneficial to increase the total adhesion magnitude beyond that provided by electroadhesion alone; and/or protection of the dielectric layer from chemicals and wear.

In some aspects, the contact layer 120 includes or is composed of a polymer. Such polymers can include polyimide, biaxially oriented polyethylene terephthalate, biaxially oriented polypropylene (BOPP), or polyvinylidene fluoride (PVDF), among others. In other aspects, the contact layer 120 includes or is composed of an inorganic insulator such as diamond, silicon dioxide, mica, boron nitride, among others. Polymers and other materials which may be included in the contact layer 120 or the back layer 110 have a maximum energy product, Uₑ (J/cm³). Electroadhesive (EA) forces are proportional to the maximum energy product, Uₑ (J/cm³) of the pad 100 in contact with the surface 125. For most materials Uₑ is linearly proportional to relative permittivity, and proportional to the square of breakdown strength. Therefore, if breakdown strength is doubled, EA forces quadruple.

The back layer 110 couples with or includes the contact layer 120. The back layer 110 may be made of various suitable materials. For example, the back layer 110 includes or is composed of a polymer, such as polyimide, biaxially oriented polyethylene terephthalate, biaxially oriented polypropylene (BOPP), or polyvinylidene fluoride (PVDF), among others. In some cases, the back layer 110 is made of the same material as the contact layer 120. The back layer 110 is coupled to the rigid backing 105, such as to the second side of the rigid backing 105. The back layer 110 may be a second layer of the pad 100.

The electrodes 115 is at least partially disposed within the back layer 110. For example, the electrodes 115 is disposed within the back layer 110 and further enclosed between the back layer 110 and the contact layer 120. In another example, the electrodes 115 is fully enclosed or encapsulated by the back layer 110. In some cases, the electrodes 115 are partially enclosed by the back layer 110, thereby leaving the electrodes 115 exposed partially or in contact with the contact layer 120 partially. In some cases, by encapsulating the electrodes 115 in the back layer 110, atmospheric breakdown and conduction through metal surfaces can be prevented. In some cases, the back layer 110 is deposited over the electrodes 115.

The electrodes 115 may be of various suitable types and arrangements of conductive materials. For example, the electrodes 115 can be patterned. In another example, the electrode 115 are round or rounded. In some cases, the electrodes 115 are interdigitated electrodes that provides adhesion to both conductive and insulative surfaces, such as the surface 125. The electrodes 115 may be flexible electrodes. In some cases, the electrodes 115 wraps around layers of the pad 100, such as the back layer 110. The electrodes 115 provides an electrostatic force on at least the surface 125. This electrostatic force causes adhesion to the surface 125. In some cases, the electrodes 115 produces an electrostatic force sufficient to provide adhesion between the electrostatic pad 100 and the surface 125. The adhesion may be at least equal to a normal force exerted on the pad 100 by, for example, the surface 125 or another normal force.

The pad 100 or its subcomponents is powered by a power source, not pictured. In some cases, the power source can provide 2-5 kV to the electrodes 115. When powered, the pad 100 adheres to the surface 125. The power source and the electrodes 115 may be connected in a manner to reduce arcing, power surges, or other loss of power in the system, such as connecting arrays of electrodes 115 with independent overcurrent protection elements (e.g., fuses) in parallel to a power source, such that a failure in one array may not cause a loss of adhesion across all arrays due to reduction of available voltage.

In some cases, one pad 100 can provide at least 6 grams-force per cm² normal to an insulative surface. In some cases, one pad 100 can provide at least 8.5 grams-force per cm² normal to a conductive surface. Arrangements of pads 100 and pads with great surface areas can provide normal forces in excess of the examples written herein.

In some aspects, the pad 100 is coupled to a system application, such as, but not limited to a track of a vehicle via a system application connection 140 provided on the deformable layer 130 side of the pad 100. The system application connection 140 may include a rigid component that is coupled with the deformable layer 130.

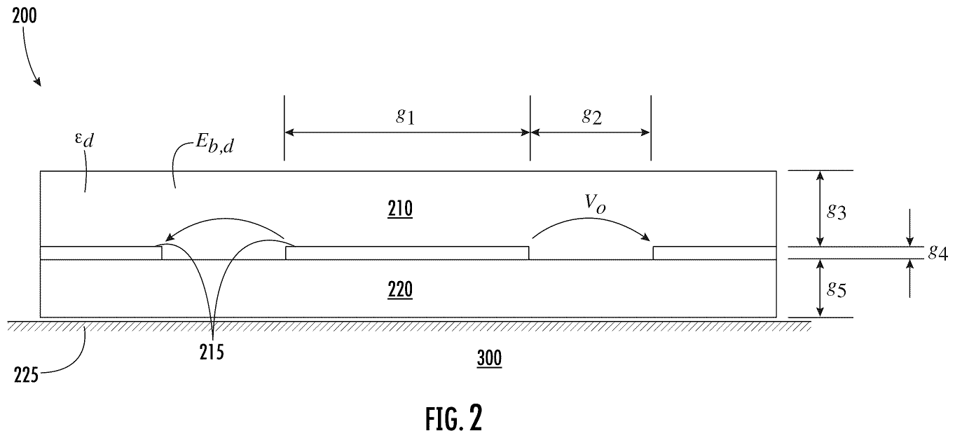

FIG. 2 depicts an example electroadhesive pad 200. The electroadhesive pad 200 (also referred to herein as the “pad 200”) may be like or share functionalities of the electroadhesive pad 100 of FIG. 1. For example, the electroadhesive pad 200 includes a back layer 210 similar to the back layer 110, electrodes 215 similar to the electrodes 115, a contact layer 220 similar to the contact layer 120, or a rigid backing (not pictured) similar to the rigid backing 105. The surface 225 can be like or include functionalities of the surface 125.

In some cases, the example pad 200 can have the properties provided in table 1. The values described herein are provided by way of example only and should not be construed as limiting the scope of the application.

TABLE 1
Example Pad Properties

| g₁ | electrode width | 100-800 | μm |
|---|---|---|---|
| g₂ | gap width | 100-800 | μm |
| g₃ | back-cover thickness | 10-40 | μm |
| g₄ | electrode thickness | 0.01-40 | μm |
| g₅ | contact layer film thickness | 10-30 | μm |
| ε_{d} | relative permittivity of back layer 210 and | 3-200 | |
| | contact layer 220 material | | |
| E_{b, d} | breakdown strength of back layer 210 | 50-3000 | kV/mm |
| | and contact layer 220 material | | |
| Vₒ | Operating voltage | 500-10000 | V |

The strongest E-field across all conditions occurs across g₅, when adhering to a conductive surface is provided as: Eₘₐₓ=Vₒ/g₅

The field across g₂ may be nonuniform such that E>V/d and is enhanced near electrode edges. Therefore, in this example, g₂ may be greater than g₅. The maximum fields through g₃ are generally less than or equal to g₅, therefore it is sufficient to make g₃≥g₅.

Since Eₘₐₓ=Vₒ/g₅, it may seem that the choice of both V₀ and g₅ are arbitrary, provided that their ratio does not exceed the material breakdown strength. In some cases, breakdown strength depends inversely on thickness. That is to say, for some materials, the thinner it is, the higher its breakdown strength. Therefore, V₀ is selected based on a practical thickness g₅ for a given back layer 210 and contact layer 220 material.

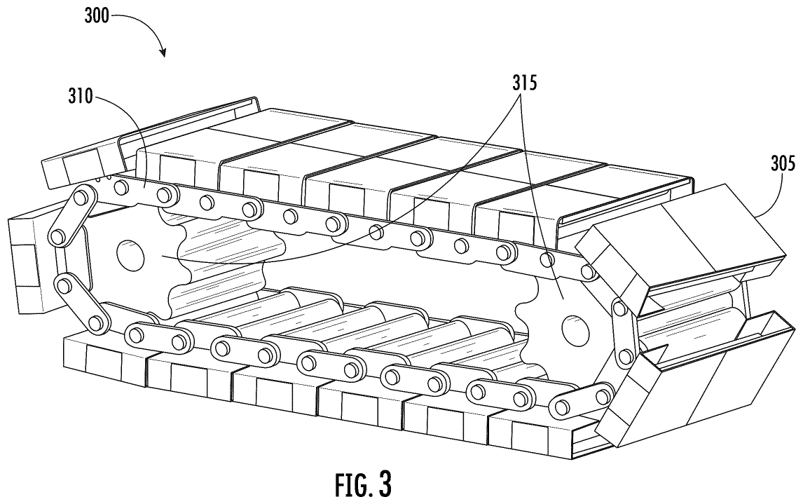

Referring to FIG. 3, in an illustrative example, a pad of the present disclosure is employed in a track system 300 for a vehicle. The track system 300, which may also be referred to herein as the “track 300”, operates to move the vehicle. In some cases, the vehicle has one or more tracks 300 to provide balance and/or to enable movement of the vehicle in multiple axis. The track 300 includes a chain 310 and one or more of the pads 305, where the pad 305 is similar to the pads 100 and 200. In a brief overview, the track 300 moves over the wheels 315 to cycle contact of pads 305 with a surface, such as the surface 125. The pads 305 in contact with the surface can electrostatically adhere to the surface.

In some applications, the track system 300 may be a continuous belt, continuous track, caterpillar track or tracked treads. In other applications, the track 300 may be segmented as illustrated in FIG. 3 (e.g. segmented electroadhesive pads attached to a continuous flexible loop or coupled by linkages). The track 300 may be a belt (e.g. a flexible fiber, canvas, rubber, etc., such as a Kégresse track). The track 300 may extend over the one or more wheels 315.

In some aspects, the track 300 is single wheel 315 around which the electrostatic pads 305 are arranged. The single wheel 315 can be a continuous wheel, or a segmented wheel such as a pedrail wheel or dreadnaught wheel.

The chain 310 provides power to the track 300, and in some aspects is a power source for the flexible electroadhesive pads 305. The track 300 may include one or more chains 310. For example, the track 300 has one “hot” chain to provide power to the track 300 and one “cold” or neutral chain to complete an electric circuit providing power to the track 300.

In some cases, the track 300 is a segmented track including a plurality of pads 305 rotated by the chain 310 to propel a vehicle. In some cases, the vehicle can include at least two continuous tracks. The two continuous tracks of this example can be parallel to one another, can be orthogonal to one another either planarly or through different planes, among other configurations.

In some cases, the track 300 is not segmented, and the pad 305 is one continuous flexible pad 305. The quantity and size of the pads 305 coupled to the track 300 may vary.

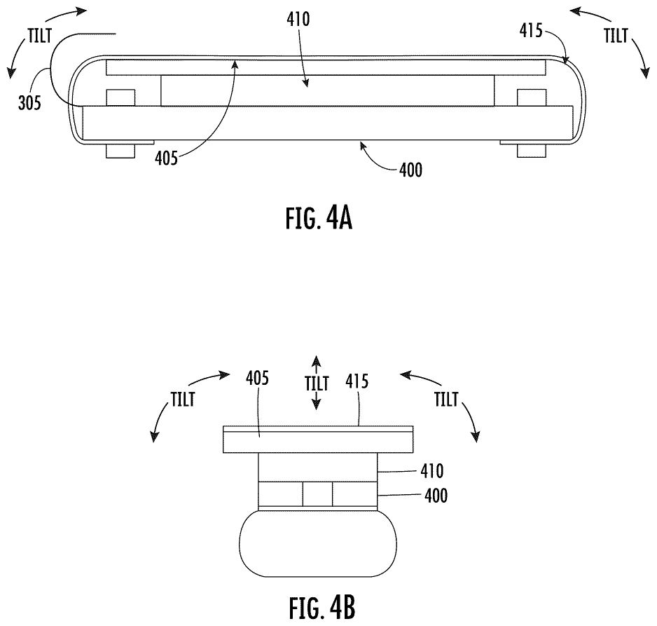

The pads 305 may couple to the track. The pads 305 can be like or include the pad 100 or 200 described herein. Referring to FIGS. 4A and 4B, the pads 305 couples to the track 300 with an attachment mechanism 400, which acts as the system application connection 140. The pad 305 includes a deformable layer 410, at least one electrode 415 (similar to the electrodes 115, 215), a rigid backing 405 (similar to the rigid backing 105), a contact layer (not depicted; similar to the contact layer 120), and/or a back layer (not depicted; similar to the back layer 110, 210).

The attachment mechanism 400 may be a rigid attachment which on one end couples to or is a part of the track 300 and on another end couples to the deformable layer 410. The deformable layer 410 has at least two opposing sides. In some cases, a first side of the deformable layer 410 couples with the rigid backing 405 and a second side of the deformable layer 410 couples to the attachment mechanism 400. In this manner, the pad 305 may be coupled to a track 300.

The deformable layer 410 can be any malleable, elastic, or material with shape memory such as an elastomer, foam, soft rubber, spring flexure, among others. To enhance contact of the electrode 415 or a contact layer (not depicted) with a surface, the rigid backing 405 is coupled with the deformable layer 410. The deformable layer 410 may physically deform to compress and tilt (see FIG. 4B), which enables the pad 305 to make contact with the surface, despite variations in the surface. The compressibility of the deformable layer 410 enables contact of the pad(s) 305 on rough or non-smooth surfaces. The rigid backing 405 and the deformable layer 410 410 enhance this contact between the pad 305 and the surface, increasing adhesion of the pad 305 to the surface beyond conventional electrostatic adhesives. In some cases, the deformable layer 410 enables the rigid backing 405 to move around track 300 and conform to potential non-flat surfaces.

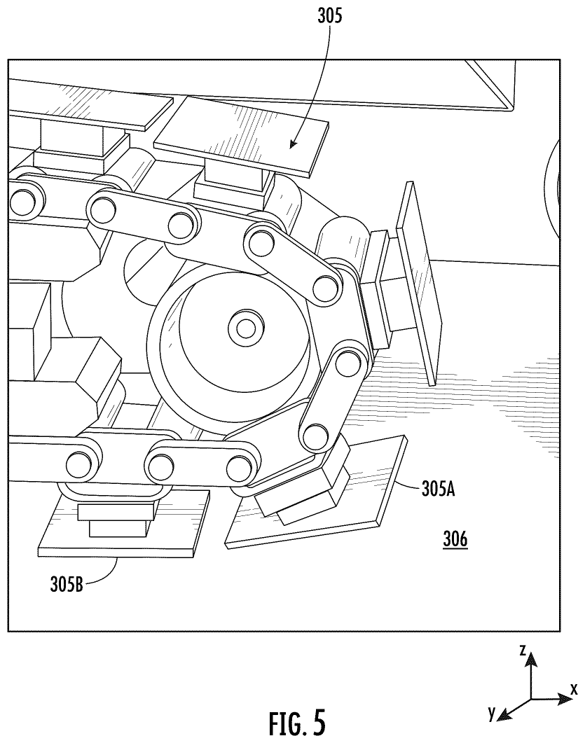

In some aspects, the rigid backing 405 may be coupled to a vehicle. In some cases, the rigid backing may be coupled to a track of the vehicle. In this manner, as the track rotates, the deformable layer 410 can compress and cause the flexible electroadhesive pad 305 to tilt to bring the pad 305 into close proximity with an external object (e.g., surface), as shown in FIG. 5. In some embodiments, a spring flexure is used instead of an elastomer.

“Tilting” can be defined as a movement of a planar surface (such as the pad 305), through one or more axes. For example, the deformable material 410 can compress upon contact of the pad 305 with a surface. This compression can enable the pad 305 to change an angle of displacement with respect to one or both axes designated by a plane parallel with the tread and/or to an axis orthogonal to the track. For example, the pad 305 can tilt in or about an x, y, z, or combination thereof direction. For example, tilting can include a vertical displacement of the pad, such as displacement which compresses the deformable layer 410 in only the “z” direction (e.g., orthogonal to the track). Vertical displacement can be further described as motion of the pad 305 towards or away from the track. In some cases, tilting can include a positive angular displacement or a negative angular displacement, e.g., the pad can tilt “forward” or “backward” with respect to the track. Likewise, the pad can tilt laterally with respect to the track. Each pad 305 may tilt independently of another. In this manner, the systems and devices described herein provide at least three independent degrees of freedom for each pad 305. In FIG. 5, pad 305A illustrates a tilting pad that is partially in contact with a surface 306 and pad 305B illustrates a tilting pad that is flat with the surface 306.

The adhesive force between the pad 305 and the surface can be a function of the number of tracks, pads, and surface area of the pads. In some cases, a net force exerted by a track on a surface is denoted by the product of a pressure, pad area, and number of pads. For example, a vehicle with two tracks may exhibit a higher adhesive force on a surface than a vehicle with one track.

In some cases, the track system and vehicle system described herein can enable a range of motions for a vehicle. For example, a vehicle can ascend or descend large inclines. In some cases, the systems described herein can enable a vehicle to travel at inclines between −85 to +85 degrees with reference to a horizontal plane. For example, the surface can be at least at a 85-degree angle respective to a horizontal axis and the adhesion provided by the systems described herein is sufficient to maintain contact of the one or more flexible electroadhesive pads to the surface. In some implementations, the track system may also allow the vehicle to travel upside-down based on the weight and adhesive force of the vehicle and the track system, respectively.

In some cases, the electrostatic force provided by the electrodes in these systems provides an adhesive force between the one or more electroadhesive pads in contact with the surface and the surface. This adhesive force can be at least equal to a normal force exerted on the one or more electroadhesive pads in contact with the surface. Stated differently, the electrostatic force provides a friction force tangent the surface. The electroadhesion force applies a normal force that forces the pad against the surface. This force results in increased friction in any direction tangent to the surface. Accordingly, electrostatic force is applied in the normal direction and provides a friction force that results slipping along directions tangent to the pad-surface interface.

This adhesive force is enabled by the contact created through the attachment mechanism 400 enabling tilting of each of the electroadhesive pads. In this manner, the systems and devices described herein can provide for electrostatic adhesion on a variety of surfaces, incline angles, and external forces.

What is claimed is:

1. A flexible electroadhesive pad, comprising:
a deformable layer comprising an elastic deformable material;
a first layer comprising a material providing rigid support, the first layer having a first side and a second side opposed to the first side, the deformable layer being coupled to the first side;
a second layer coupled with the second side of the first layer; and
one or more electrodes at least partially disposed within the second layer, wherein the one or more electrodes are configured to generate an electrostatic force to cause adhesion of the flexible electroadhesive pad to a surface.

2. The flexible electroadhesive pad of claim 1, further comprising a third layer coupled with the second layer, wherein the third layer is adapted to contact the surface.

3. The flexible electroadhesive pad of claim 1, wherein the electrostatic force provides adhesion between at least one of a plurality of layers including the deformable layer, the first layer, and the second layer, and the surface at least equal to a normal force exerted on the deformable layer.

4. The flexible electroadhesive pad of claim 1, wherein the one or more electrodes are flexible electrodes.

5. The flexible electroadhesive pad of claim 1, wherein a first side of the deformable layer is coupled with the first side of the first layer and a second side of the deformable layer opposed to the first side of the deformable layer is coupled to a system application connection that comprises a rigid material.

6. The flexible electroadhesive pad of claim 5, wherein the system application connection is adapted to couple the deformable layer to a track of a vehicle.

7. The flexible electroadhesive pad of claim 1, wherein the deformable layer is adapted to elastically deform based on a contour of the surface.

8. The flexible electroadhesive pad of claim 1, wherein the elastic deformable material of the deformable layer is an elastomer, a foam, a soft rubber, or a spring flexure.

9. The flexible electroadhesive pad of claim 1, wherein the second layer comprises a material including at least one of a polymer, a biaxially oriented polyethylene terephthalate, a biaxially oriented polypropylene, or a polyvinylidene fluoride.

10. The flexible electroadhesive pad of claim 1, wherein the first layer comprises a magnetorheological material that changes based on a magnetic field.

11. The flexible electroadhesive pad of claim 1, wherein the first layer comprises a material having unchanging rigidity.

12. A flexible electroadhesive pad, comprising:
a body including:
a deformable layer comprising an elastic deformable material;
a rigid layer comprising a material providing inelastic support and coupled to the deformable layer at a first side of the rigid layer;
a back layer coupled to a second side of the rigid layer; and
a contact layer coupled to a side of the back layer different from that of the rigid layer; and
one or more electrodes at least partially disposed within the back layer, wherein the one or more electrodes are configured to generate an electrostatic force to have the body adhere to a surface with the contact layer contacting the surface.

13. The flexible electroadhesive pad of claim 12, wherein the electrostatic force maintains an adhesion of the body to the surface that is at at least an eighty-five 85-degree angle respective to a horizontal axis.

14. The flexible electroadhesive pad of claim 12, wherein the electrostatic force provides adhesion between at least one of a plurality of layers including the deformable layer, the first layer, and the second layer, and the surface at least equal to a normal force exerted on the deformable layer.

15. The flexible electroadhesive pad of claim 12, wherein the deformable layer is adapted to elastically deform based on a contour of the surface to have the body contact the surface.

16. The flexible electroadhesive pad of claim 12, wherein the elastic deformable material of the deformable layer is an elastomer, a foam, a rubber, or a spring flexure.

17. The flexible electroadhesive pad of claim 12, wherein the rigid layer comprises a magnetorheological material that changes based on a magnetic field.

18. The flexible electroadhesive pad of claim 12, wherein the rigid layer a material having unchanging rigidity.

19. A vehicle system comprising:
one or more tracks; and
one or more of the flexible electroadhesive pad of claim 1 coupled to the one or more tracks, wherein, for each flexible electroadhesive pad, the deformable layer is coupled to a track among the one or more tracks.

20. The vehicle system of claim 19, wherein each track includes a rigid attachment that is coupled to the deformable layer.
